(19) United States
(12) Patent Application Publication
(10) Pub. No.: US 2023/0413831 A1
(43) Pub. Date: Dec. 28, 2023

(54) APPARATUS AND METHOD FOR MULTIVARIATE PREDICTIVE MODEL-BASED BAKING PROCESS CONTROL

(71) Applicant: Intercontinental Great Brands LLC, East Hanover, NJ (US)

(72) Inventors: Wu Ge, East Hanover, NJ (US); Thomas Adam Nosek, East Hanover, NJ (US)

(21) Appl. No.: 18/035,919

(22) PCT Filed: Nov. 1, 2021
(86) PCT No.: PCT/US2021/057521

§ 371 Date: May 8, 2023

Related U.S. Application Data
(60) Provisional application No. 63/113,773, filed on Nov. 13, 2020.

(51) Int. Cl. A21C 11/16; A21D 8/06; A21C 5/00; A21B 1/48; A21B 7/00

(52) U.S. Cl. CPC A21C 11/16; A21D 8/06; A21C 5/00; A21B 1/48; A21B 7/00

(57) ABSTRACT

An apparatus (10) for controlling manufacture of baked products includes a piece forming device (16) configured to form dough pieces b.v reshaping dough lumps, a tunnel oven (22), at least one sensor (28) configured to detect parameters associated with the dough pieces; and a controller (40). The controller (40) correlates parameters associated with the dough pieces (80), target parameters of the baked products, ambient environmental conditions, and settings and conditions of the tunnel oven (22) to generate, based on a multivariate predictive control model, baking parameters of the tunnel oven (22) predicted by the controller to cause the tunnel oven to produce, from the dough pieces inserted into the tunnel oven, the baked products (90) with the target parameters. The controller (40) is also configured to control the tunnel oven (22) to run these baking parameters while the dough pieces are baked in the tunnel oven to produce the baked products having the target parameters.

### FIELD

This disclosure relates to processing of baked products, and more specifically, to using a multivariate predictive control model to control the operating parameters of an oven when baking the products in the oven.

### BACKGROUND

Generally, the consumer-desired properties (e.g., flavor, texture, color, mouthfeel, etc.) of baked products (e.g., biscuits, crackers, rotary-molded sweet cookies, extruded products, etc.) at least in part define the consumer-perceived quality thereof. Since dough is the precursor of the consumable baked (e.g., biscuit) products, dough manufacturers aim to produce a dough which, when baked in an oven, results in a baked product (e.g., a biscuit) having the target parameters (e.g., moisture content, weight, color, thickness, etc.) that maximally match consumer-desired characteristics. However, the natural variability of the ingredients of biscuit dough, as well as the variability inherent to the manufacturing processes of biscuit products from biscuit dough may result in variability in the resulting baked biscuit product between batches. As a result of this variability between batches, some batches of the baked biscuit products may represent commercially desirable products that would be packaged and sold to consumers, while some batches of the baked biscuit products may represent commercially undesirable products, which fail to meet the quality specifications, and would be thrown away or reworked, leading to process inefficiencies and increased process cost for the biscuit product manufacturers.

Biscuit baking is a complex process with multiple inputs and multiple outputs. A typical commercial biscuit baking oven has 5 to 10 zones, which may be independently controllable. Each oven zone has multiple manipulated process variables (e.g., burner output, temperature, heat distribution, exhaust level, etc.) that can affect the quality and production efficiency of the baked product. As such, oven control in connection with baking a biscuit product may include manipulation/adjustment of as many as a few dozen process variables. Conventional biscuit ovens typically operate in a mode, where the bakers have to manually adjust many of these input variables pre- and post-baking to achieve a commercially desirable baked biscuit product having product quality attributes (e.g., dry weight, moisture level, color, thickness, visual defects, texture, etc.) that are within the manufacturer's specifications. Generally, this is a trial-and-error process, where the bakers bake the dough in the oven to prepare the baked products, then measure the attributes of the baked products using multiple analytical methods (which are often tedious, error-prone, and time-consuming), and then try to adjust the baking parameters of the oven in view of the ambient environmental conditions, actual final baked product attributes, and the target (i.e., commercially desirable) baked product attributes to achieve baked products having the commercially desirable attributes. As a result, it is generally very difficult and inefficient for bakers to use manual process measurement control for purposes of achieving consistent baked product quality and high production efficiency. Hence, there is a need for improved processing of baked products that employs an efficient process to achieve baked products having high quality, commercially desirable attributes.

### SUMMARY

The present application is generally directed to an apparatus (and associated methods) for processing baked (e.g., biscuit, cracker, cookie, etc.) products that overcomes at least some of the above-described disadvantages of conventional baking systems. In particular, a purpose of the apparatus described herein is to use a multivariate predictive control model to set the baking parameters of the oven (e.g., tunnel oven, etc.) in order to decrease the baking process variability, while at the same time reducing the variability and improving the quality attributes of the baked products.

In some embodiments, an apparatus for controlling manufacture of baked products comprises a piece forming device configured to form dough pieces by reshaping dough lumps (e.g., mixed, extruded, etc.), wherein the dough pieces formed by the piece forming device represent precursors of the baked products. In some circumstances, the piece forming device may form dough pieces in the form of a continuous, one-piece extrusion representing precursors of the baked products. In other words, the dough pieces may be in the form of a continuous extrusion that may be separated into individual baked products prior to baking or after baking. The dough pieces may be represented in a single extrusion that is later cut or otherwise separated.

The apparatus further comprises a tunnel oven comprising at least one section including one or more zones, the tunnel oven being configured to bake the dough pieces to provide the baked products. The apparatus also comprises at least a first sensor configured to detect parameters associated with the dough pieces formed by the piece forming device. In addition, the apparatus comprises a controller including a programmable processor and being operatively coupled to the tunnel oven. The controller is configured to: obtain electronic data representing the parameters associated with the dough pieces formed by the piece forming device and detected by the first sensor, obtain electronic data representing target parameters of the baked biscuit products to be manufactured from the dough pieces in the tunnel oven; obtain electronic data representing ambient environmental conditions, and obtain electronic data representing settings and conditions of the tunnel oven. The controller is further configured to: correlate the obtained parameters of the dough pieces, target parameters of the baked biscuit products, ambient environmental conditions, and settings and conditions of the tunnel oven to generate, based on a multivariate predictive control model, a first set of baking parameters of the tunnel oven predicted by the controller to cause the tunnel oven to produce, from the dough pieces inserted into the tunnel oven, the baked biscuit products with the target parameters; and control the tunnel oven to run the first set of baking parameters, generated by the controller based on a correlation of the obtained parameters of the dough pieces, target parameters of the baked biscuit products, ambient environmental conditions, and settings and conditions of the tunnel oven, while the dough pieces are baked in the tunnel oven to produce the baked biscuit products having the target parameters.

As mentioned above, conventional control of the baking of biscuit products in a tunnel oven is typically done by trial and error, i.e., by way of post-baking manual assessment of the baked product attributes (e.g., moisture content, weight, color, etc.) and the responsive readjustment of the future baking parameters, which cannot influence or benefit the already baked product. While this conventional control may benefit the products that are baked in the future, any change in ambient conditions not accounted for in the analysis of the first batch of the baked products may defeat the purpose of such retrospective conventional control, since, given the change in the ambient conditions, the oven parameters manually set after analyzing the first batch of baked products may no longer be optimal for producing a second batch of baked products having the desired properties. Typically, to account for process disturbances such as environmental condition changes, a predetermined excess degree of baking may be performed to ensure, for example, that all baked products meet a desired moisture content level. In other words, the predetermined excess degree of baking accounts for expected process, environment or raw material disturbances, for example, and thus represents over-baking for a proportion of the product.

In contrast, the apparatus and methods according to some of the exemplary embodiments described herein are based at least in part on identification/detection of certain parameters associated with the dough pieces formed during the piece forming operation (i.e., by the optional kibbler and/or rotary molder, etc.). These identified/detected parameters (which may be detected by directly sensing the parameters of the dough pieces themselves, or by calculating the parameters of the dough pieces based on the sensing of the operational parameters (e.g., current, power, torque, die roll speed, die roll gaps, knife height, etc.) of the kibbler and/or rotary molder, serve as indicators of the required baking parameters for those particular dough pieces to result in baked biscuit products having the commercially desired final parameters. Hence, as described in more detail below, in some aspects, by detecting the parameters associated with the dough pieces formed by the piece forming device (e.g., kibbler and/or rotary molder, etc.), the baking parameters of the tunnel oven may be preset specifically for these dough pieces (while also taking into account any other factors that may affect the baking process in the tunnel oven (e.g., ambient conditions, etc.) to result in baked products having the desired final attributes.

As such, the apparatus according to the embodiments described herein performs the baking of the dough pieces to the desired final product attributes (e.g., moisture content, weight, height, thickness, color, etc.) more efficiently and more consistently, since the baking parameters of the oven are preset in advance of the baking based on an analysis of at least the characteristics associated with the dough pieces going into the oven, the ambient environmental conditions, and the desired target attributes of the final baked products coming out of the oven. In some aspects, for example, since the baking parameters of the tunnel oven are controlled appropriately for the dough pieces having certain (pre-detected) parameters, the oven may be controlled to start the baking with a higher/lower heat input or higher/lower steam removal rate, as appropriate for the dough pieces going into the oven. As such, the efficiency of the baking may be increased, since each batch of dough pieces is baked using preset baking parameters determined by the controller of the oven to be most likely to result in a final baked product having commercially desired final product attributes (rather than retroactively adjusting the baking parameters of the oven for the second batch of dough pieces after analyzing the final attributes of the first batch of baked products in view of the attributes of the first batch of the dough pieces, the ambient environmental conditions, and the oven parameters used to bake the first batch).

The settings and conditions of the tunnel oven may include at least one of temperature, humidity, pressure, dampers, exhausts, fans in at least one of the sections of the tunnel oven, and throughput of the tunnel oven. The target parameters of the baked products may include at least one of texture, flavor, moisture content, weight, height, thickness, and color.

In some embodiments, each of the sections of the tunnel oven includes at least one zone independently controllable by the controller. In one exemplary embodiment, the sections of the tunnel oven comprise: a first section including three zones; a second section including two zones; and a third section including two zones, and the tunnel oven is configured to permit the controller to set independent parameters in each of the zones of each of the first, second, and third sections.

In certain aspects, the apparatus further comprises an electronic database in communication with the controller and configured to store electronic data. The electronic data stored in the electronic database may include, for example, electronic data representing the parameters associated with the dough pieces formed by the piece forming device and detected by the first sensor; electronic data representing target parameters of the baked biscuit products to be manufactured from the dough pieces in the tunnel oven; electronic data representing the ambient environmental conditions; electronic data representing settings and conditions of the tunnel oven; and electronic data representing the first set of baking parameters generated by the controller.

In some implementations, the apparatus includes at least a second sensor configured to detect parameters associated with the baked biscuit products coming out of the tunnel oven, and the controller is configured to: obtain electronic data representing the parameters associated with the baked biscuit products coming out of the tunnel oven and detected by the second sensor and determine whether the parameters of the baked biscuit products coming out of the tunnel oven match the target parameters of the baked biscuit products. Then, if the parameters of the baked biscuit products coming out of the tunnel oven do not match the target parameters of the baked biscuit products, the controller is configured to correlate the obtained parameters of the dough pieces, target parameters of the baked biscuit products, parameters of the baked biscuit products coming out of the tunnel oven, ambient environmental conditions, and settings and conditions of the tunnel oven to generate, based on the multivariate predictive control model, a second set of baking parameters of the tunnel oven predicted by the controller to cause the tunnel oven to produce, from the dough pieces inserted into the tunnel oven, the baked biscuit products with the target parameters.

In certain aspects, the second sensor is configured to measure at least one of a moisture content, thickness, weight, stack height, and color of the baked biscuit products coming out of the tunnel oven. In one approach, the electronic database further stores the electronic data representing the parameters of the baked biscuit products coming out of the tunnel oven and detected by the second sensor; and electronic data representing the second set of baking parameters generated by the controller.

In some embodiments, a method for controlling manufacture of baked products comprises: reshaping dough lumps to form dough pieces by a piece forming device, the dough pieces representing precursors of the baked products; providing a tunnel oven comprising at least one section and configured to bake the dough pieces to provide the baked products; providing at least a first sensor; detecting, via the first sensor, parameters associated with the dough pieces formed by the piece forming device; and providing a controller including a programmable processor and being operatively coupled to the tunnel oven. The method further includes obtaining, via the controller: electronic data representing the parameters associated with the dough pieces formed by the piece forming device and detected by the first sensor; electronic data representing target parameters of the baked products to be manufactured from the dough pieces in the tunnel oven; electronic data representing ambient environmental conditions; electronic data representing settings and conditions of the tunnel oven; and correlating, by the controller, the obtained parameters of the dough pieces, target parameters of the baked products, ambient environmental conditions, and settings and conditions of the tunnel oven. The method further includes, based on the correlating, generating by the controller, using a multivariate predictive control model, a first set of baking parameters of the tunnel oven predicted by the controller to cause the tunnel oven to produce, from the dough pieces inserted into the tunnel oven, the baked products with the target parameters; and producing the baked products having the target parameters by baking the dough pieces in the tunnel oven while controlling, via the controller, the tunnel oven to run the first set of baking parameters, generated by the controller based on a correlation of the obtained parameters of the dough pieces, target parameters of the baked biscuit products, ambient environmental conditions, and settings and conditions of the tunnel oven.

### BRIEF DESCRIPTION OF THE DRAWINGS

Disclosed herein are embodiments of an apparatus and methods pertaining to using a multivariate predictive control model to control manufacture of baked products in an oven. This description includes drawings, wherein:

FIG. 1 is a schematic diagram depicting an apparatus for controlling manufacture of baked products in a tunnel oven in accordance with some embodiments;

FIG. 2 is a schematic diagram of a dough piece forming device in accordance with some embodiments;

FIG. 3 is a schematic diagram of a tunnel oven in accordance with some embodiments;

FIG. 4 is a functional diagram of an exemplary controller usable with the apparatus of FIG. 1 in accordance with some embodiments:

FIG. 5 is a flow chart diagram of an exemplary method of controlling manufacture of baked products in an oven in accordance with some embodiments; and

FIG. 6 is a flow chart diagram of another exemplary method of controlling manufacture of baked products in an oven in accordance with some embodiments.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment. In addition, it will be appreciated that various features described in reference to a particular embodiment may be interchangeably used in combination with one or more other embodiments described herein.

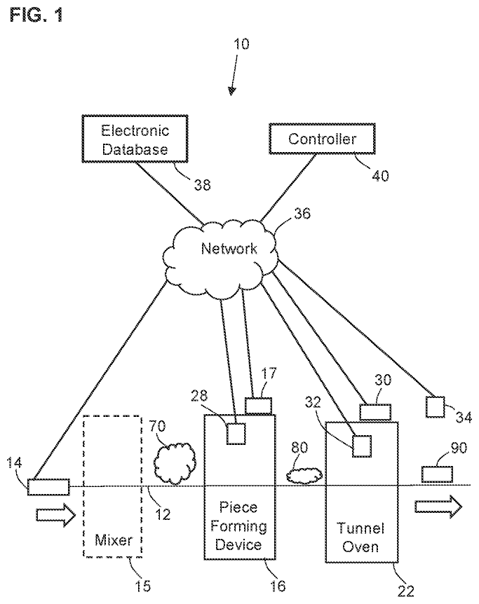

FIG. 1 illustrates an exemplary embodiment of an apparatus 10 for controlling manufacture of baked products such as biscuits, crackers, cookies, and the like. In the embodiment shown in FIG. 1, the apparatus 10 includes a conveyor 12 including a product advancement surface that is configured to support thereon a plurality of dough lumps 70 (which may be dough that is made using a mixer, extruder, or the like, and which may be reshaped into the smaller dough pieces 80 as described below), a plurality of dough pieces 80 (which serve as the precursors to the baked products 90), and a plurality of baked products 90. While the conveyor 12 is illustrated for the sake of simplicity as including only one dough lump 70, only one dough piece 80, and only one baked product 90, it will be appreciated that, depending on the scale of operation of the apparatus 10, the product advancement surface of the conveyor 12 may be large enough to simultaneously concurrently transport a large number (e.g., dozens, hundreds, etc.) of dough lumps 70, dough pieces 80, and baked products 90.

In the embodiment shown in FIG. 1, the conveyor 12 is operatively coupled to a control unit 14 configured to activate the conveyor 12, deactivate the conveyor 12, and set the speed of the conveyor 12. In some aspects, the control unit 14 is configured to receive, via a wired or a wireless connection (e.g., over the network 36), control signals from a remote source (e.g., a controller 40, which will be described in more detail below).

In some embodiments, the ingredients (e.g., various combinations of flour, water, sugar, oil, salt, emulsifier, etc.) that form the dough that is used to produce the baked products 90 are initially mixed in a mixer. To that end, in some embodiments, the exemplary apparatus of FIG. 1 may include a mixer 15, where the dough ingredients are mixed to achieve one or more dough lumps 70 having the consistency/texture and/or temperature desirable for achieving final baked products 90 having commercially desirable attributes. Notably, the mixer 15 is optional, and, in some embodiments, the apparatus 10 does not include the mixer 15, such that dough lumps 70, extruded dough bits, or the like are pre-made (e.g., in a mixer, extruder, or the like) independently of the apparatus 10, and travel on the conveyor 12 into the piece forming device 16 for processing, which is described in more detail below. In some exemplary embodiments, the mixer 15 is an upright mixer that disperses the ingredient particles uniformly therein and results in an improved homogeneity of the dough. In some embodiments, the mixer 15 is a jacket (also known as a jacketed) mixer, which includes one or more water jackets that are able to heat the ingredients being mixed in the mixer 15. In some embodiments, the mixer 15 is a continuous mixer 15. It will be appreciated that, in the embodiments, where the apparatus 10 includes the optional mixer 15, any other suitable mixer 15 or an equivalent dough making device may be used to prepare the dough that will be processed by the piece forming device 16.

Generally, a dough lump 70 may be a mixture of a solid phase and a liquid phase or alternatively, a dense/viscous suspension, exhibiting properties that lie somewhere between a liquid substance and solid substance. Many doughs may be similar to solids in that they retain their shapes against gravity. However, at high shear stresses, the doughs may begin to flow, thereby implying a yield (i.e., critical) stress for the solid to liquid transition. Such doughs typically exhibit thixotropic behavior, such that their viscosities decrease with time, suggesting structure breakup.

The rheology of the dough mixture may vary dependent on the mixing process variables, including but not limited to: characteristics of the ingredients, ambient conditions (temperature, humidity, etc.), and/or residence time of the ingredients in the mixer (i.e., the mixing time). In one aspect, the amount and temperature of the water added to the ingredient mixture may be varied in order to compensate for variability in the flour strength and ensure that the dough lump 70 produced in the mixer 15 is consistent from batch to batch.

In some embodiments, after the dough ingredients are mixed in the mixer 15 to form the dough lump 70, the dough lump 70 may be left in the mixer 15 and/or (after being dumped from the mixer 15 onto the conveyor 12) left on the surface of the conveyor 12 for a period of time sufficient to achieve a dough lump 70 having the desired characteristics, before transporting the dough lump 70 on the conveyor 12 into the dough piece forming device 16. Generally, the consistency of the dough lump 70 may be viscous and/or crumbly.

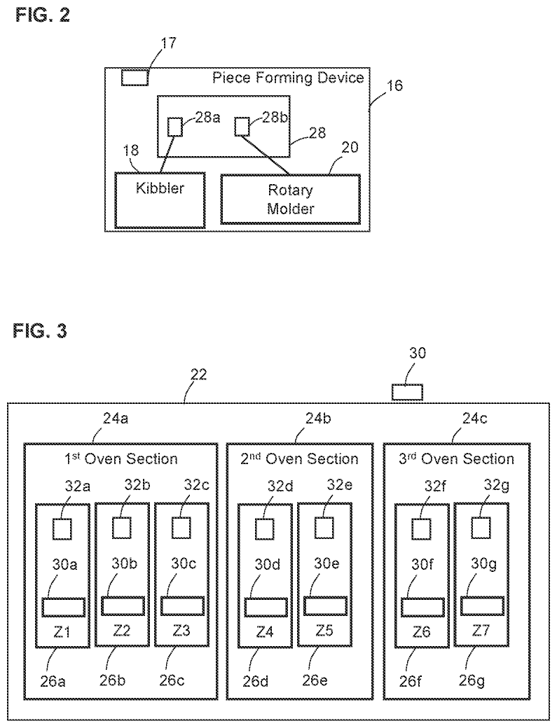

With reference to FIG. 1, the exemplary apparatus 10 of FIG. 1 further includes a dough piece forming device 16. In some aspects, the dough piece forming device 16 reshapes (e.g., breaks up, extrudes, etc.) the dough lumps 70 traveling on the conveyor 12. An exemplary dough piece forming device 16 according to the exemplary embodiment shown in FIG. 2 includes a kibbler 18 for kibbling (e.g., breaking, deagglomerating, etc.) the dough lumps 70 to provide smaller-sized dough kibbles. In addition, the exemplary dough piece forming device 16 of FIG. 2 includes a rotary molder 20 for molding the smaller-sized dough kibbles formed by the kibbler 18 to provide the molded dough pieces 80. In some embodiments, the dough piece forming device 16 includes an extruder and is thus configured to reshape the dough lumps 70 into the dough pieces 80 by extruding the dough lumps 70 into a continuous mass, which represents the precursors of the baked products 90. In some aspects, the piece forming device 16 is configured to extrude a plurality of parallel, continuous dough masses. The continuous mass of dough may be separated into a plurality of dough pieces 80 in the piece forming device 16 prior to baking. On the other hand, the continuous mass of dough may be first baked and then separated (e.g., by a cutting device such as a blade) into a plurality of discreet baked products 90 after baking in the tunnel oven 22.

In some aspects, when a rotary molder 20 is used, the kibbled dough pieces that result from the kibbling of the dough lumps 70 are fed evenly and consistently to the hopper of the rotary molder 20, maintaining an even level across the width of the hopper. In one implementation, the even level across the width of the hopper of the rotary molder 20 may be ensured by including one or more sensors (e.g., laser sensors) that detect the height of the ingredients/mass in the hopper and thereby detect any level unevenness in the hopper. In certain embodiments, the weight of the dough pieces 80 resulting in from the action of the rotary molder 20 may be fine-tuned by adjusting the gap between the corrugated roll, die roll, and/or the height of the knife used to cut/mold the dough pieces 80. The molded dough pieces 80, after being formed by the piece forming device 16 are then baked (as will be described in more detail below) to result in the final baked biscuit products 90 (e.g., baked, rotary molded sweet cookies). It will be appreciated, of course, that the apparatus 10 is suitable for processing a wide variety of baked products (e.g., crackers or the like), and is not limited to production of just biscuit products.

With reference to FIGS. 1 and 2, the apparatus 10 further includes at least one sensor 28 configured to detect the operational parameters of the dough piece forming device 16 and/or the attributes of the dough pieces 80 formed by the dough piece forming device 16. As used herein, the term “sensor” is used to generally refer to any device that is configured to detect/sense/measure any characteristic (e.g., moisture, weight, height, thickness, roundness, color, weight, or the like) of the dough 70, the dough pieces 80 produced in the piece forming device 16 and the baked products 90 baked in the tunnel oven resulting from the dough 70 and/or detect/sense/measure any operational parameter (e.g., current, power, torque, die roll speed, die roll gaps, knife height, temperature (e.g., ambient, tunnel oven, etc.), heat (e.g., top oven heat, bottom oven heat, etc.), air recirculation speed and pressure in the oven, relative humidity, etc.) of any device of the apparatus 10 used to prepare/repurpose/bake the dough. In addition, which may be detected by directly sensing the parameters of the dough pieces themselves, or by calculating the parameters of the dough pieces based on the sensing of the operational parameters (e.g., current, power, torque, die roll speed, die roll gaps, knife height, etc.

In particular, in the exemplary embodiment illustrated in FIG. 2, the at least one sensor 28 includes a first sensor 28a configured to detect and/or determine the consistency of the dough pieces 80 coming out of the dough piece forming device 16 by detecting and/or measuring one or more parameters (e.g., current, voltage, power, torque, speed, pressure, etc.) of the kibbler 18, and a second sensor 28b configured to detect and/or determine the characteristics (e.g., moisture content, weight, texture, etc.) of the dough pieces 80 and by detecting and/or measuring one or more parameters (e.g., die roll speed, die roll gap, knife height, extraction rate, etc.) of the rotary molder 20. In one exemplary embodiment, the sensor 28a may be a near-infrared (NIR) sensor, and the second sensor 28b may be a weight scale. In certain implementations, the sensor 28a detects the current output and, more particularly, the peak moving average current value of the electric motor of the kibbler 18, and translates this value into the predicted consistency/texture of the dough pieces 80 produced by the kibbler 18.

In some embodiments, the first sensor 28 is configured to detect a current, a voltage, a power, a torque, a speed and/or a pressure of the piece forming device 16 (e.g., of the kibbler 18). In one approach, the kibbler 18 includes an electric motor and the current, power, torque, speed and/or pressure is drawn by/applied by the electric motor, and sensed by the first sensor 28a (which may be implemented as a single sensor or a combination of multiple sensors). Generally, such sensed measurements of the operation of the kibbler 18 may be accurate indicators of the consistency (e.g., moisture content, thickness, viscosity, etc.) of the dough pieces formed in the kibbler 18. Thus, the formation and the resulting attributes of the dough pieces 80 produced in the piece forming device 16 may be controlled based, at least in part, on detecting and/or interpreting such indicators of the consistency of the dough. In some embodiments, the moisture content of the dough pieces 80 formed in the piece forming device 16 and entering the tunnel oven 22 may be in range of about 13% to about 16%. Notably, percentages described in this application in relation to the ingredients of the dough pieces 80 and/or the baked biscuit products 90 are by weight unless otherwise indicated.

In some embodiments, the first sensor 28 comprises and/or is a soft-sensor (also known as a software sensor). Generally, soft-sensors may be used to measure one or more process or quality attributes (e.g., of the dough pieces 80 formed in the piece forming device 16) that are calculated by software from a variety of inputs variables using statistical treatment (e.g., Partial Least Squares (PLS), Recursive Least Squares (RLS), etc.). In some aspects, the first sensor 28 is a soft sensor that measures/detects the weight of the dough pieces 80 entering the tunnel oven 22.

In some embodiments, the first sensor 28 is operatively/communicatively coupled to the piece forming device 16, and may be internal to the piece forming device 16 (as shown by way of example in FIGS. 1 and 2), or may be external to the piece forming device 16. In addition, as mentioned above, the first sensor 28 may be configured as a single sensor 28 as shown in FIG. 1, or as multiple (e.g., first and second) sensors 28a and 28b as shown in FIG. 2. In some aspects, the first sensor 28 is configured for communication with the controller (which will be described in more detail below), such that the first sensor 28 is able to detect/determine the characteristics associated with the dough pieces formed in the piece forming device 16, and to transmit this information (via a wired or wireless connection (e.g., network 36)) to the controller 40. In the exemplary embodiment shown in FIG. 1, the piece forming device 16 includes a transceiver 17 (which may be external as shown in FIG. 1 or internal as shown in FIG. 2) configured for two-way communication over the network 36 with the controller 40 to permit the controller 40 to monitor and/or modify/preset the operating parameters of the piece forming device 16 to achieve dough pieces 80 having the desired parameters.

With reference back to FIG. 1, the exemplary apparatus 10 further includes an oven 22 that bakes the dough pieces 80 to provide the baked biscuit products 90. In some embodiments, the oven 22 is a tunnel oven, although any oven suitable for making baked products 90 from the dough pieces 80 may be used. In the embodiments shown in FIGS. 1 and 3, the oven 22 includes a transceiver 30 configured for two-way (wired or wireless) communication over the network 36 with the controller 40 (which will be described in more detail below). Generally, while the air temperature in a tunnel oven is conventionally controlled by a proportional-integral-derivative (PID) feedback closed-loop system, the controller 40 of the apparatus 10 is configured to monitor the actual temperature in the tunnel oven 22 in relation to a preset temperature point (determined by the controller 40 to result in baked biscuit products 90 having the desired characteristics), and to activate/control the burner of the tunnel oven 22 in order to achieve and/or maintain the preset (e.g., optional) temperature point. In some embodiments, the three parameters of the PID algorithm are fine-tuned such that the controller 40 is able to respond accurately and promptly (e.g., by sending one or more control signals to the transceiver 30 of the tunnel oven 22) to variations between the preset desired temperature point and the actual baking temperatures detected in the tunnel oven 22 by one or more sensors 32a-32g, which will be described in more detail below.

As shown in more detail in FIG. 3, the exemplary oven 22 is a tunnel oven that includes one or more sections. In particular, the exemplary tunnel oven 22 shown in FIG. 3 includes a first section 24a, a second section 24b, and a third section 24c for continuously baking the dough pieces 80 as they pass through the tunnel oven 22 while traveling on the conveyor 12. In the embodiment illustrated in FIG. 3, the first section 24a of the tunnel oven 22 includes three zones 26a, 26b, and 26c, the second section 24b of the tunnel oven 22 includes two zones 26d and 26e, and the third section 24c of the tunnel oven 22 includes two zones 26f and 26g.

The baking in the exemplary multi-zone tunnel oven 22 may be functionally divided into three sections 24a-24c, which are described in turn below. Generally, the biscuit forming and baking process is extremely complex and involves a large number of input/output variables. As such, there is a strong need to develop an advanced process control solution capable of manipulating dozens of input process variables to ensure that multiple product quality attributes of the final baked products are well-balanced to achieve commercially desirable products.

The first section 24a of the tunnel oven 22 is generally associated with leavening and rising. Here, the biscuit height increases after the dough pieces 80 enter the tunnel oven 22. Generally, this process is driven by a combination of gas release by leavening agents, gas expansion, and steam formation, as well as (and primarily) by the heat transferred to the dough pieces 80 in the early zones 26a-26c of the tunnel oven 22, and is closely linked to structure development of the baked biscuit products 90, which is critical for the biscuits to develop the texture desired by the consumers. In addition, the rising process is influenced by top heat flux, bottom heat flux, leavening agents, dough rheology, dough moisture content, relative humidity of the air inside the tunnel oven 22, etc.

In order for the final baked biscuit product 90 to reach an optimum (i.e., commercially desirable) volume, it is important that the exterior surface of the dough pieces 80 is not dried pre-maturely in the tunnel oven 22, since a hard/dry surface will likely undesirably hinder the expansion of the dough pieces 80. Generally, when the dough pieces 80, which are at an ambient temperature of about 20-30° C., enter the tunnel oven 22 and encounter the hot air in the first section 24a of the tunnel oven 22, moisture will condense on the surface of the dough pieces 80. Depending upon the specific product, condensation can advantageously keep the surface of the dough pieces 80 from hardening too fast, but the latent heat that is released assists in raising the temperature of the dough pieces 80. As such, in some circumstances it can be beneficial to maintain a controlled humid atmosphere in the first section 24a (and its associated zones 26a-26c) of the tunnel oven 22. This is an example of the interrelatedness of various parameters to the baking process that can be predicted and adjusted using the equipment and associated methods described herein.

In some specific implementations, steam may be injected into one or more zones 26a-26c of the first section 24a of the tunnel oven 22 in order to raise the relative humidity in the first section 24a. In some embodiments, bottom heat may be raised in one or more of the zones 26a-26c of the first section 24a of the tunnel oven 22 with the aim of increasing the stack height of the final baked biscuit products 90 coming out of the tunnel oven 22. On the other hand, increased top heat in one or more of the zones 26a-26c of the first section 24a of the tunnel oven 22 may lead to early crust formation and the decreased stack height of the final baked products 90. This is another example of the interrelatedness of various parameters to the baking process that can be predicted and adjusted using the equipment and associated methods described herein.

The second section 24b of the tunnel oven 22 is generally associated with moisture removal. Here, the temperature of the dough pieces 80 being baked in the tunnel oven 22 plateaus, as most of the input heat goes into moisture removal in the middle zones 26d and 26e of the second section 24b of the tunnel oven 22, after the gluten has hydrated and the structure of the dough pieces 20 has formed more fully. In some aspects, a crust forms on the surface of the dough pieces 80 in the second section 24b of the tunnel oven 22, as the moisture evaporates from the exterior surface of the dough pieces 80.

Without wishing to be limited to theory, more moisture may be lost from the surface of the dough pieces 80 in the second section 24b of the tunnel oven 22, causing a dry crust to slowly move towards the center of the dough pieces 80. Sometimes, a layer of steam is formed around the surface of the dough pieces 80 as moisture is vaporized by the heat from the dough pieces 80. In some aspects, humidity of the air in the second section 24b may be adjusted within certain extent by manipulating exhaust levels of the tunnel oven 22. Without wishing to be limited by theory, monitoring and control of the air humidity in the second section 24b(which is performed by the controller 40, as discussed in more detail below) is important, since increasing heat in the zones 26d and 26e of the second section 24b of the tunnel oven 22 can undesirably lead to increased dehydration and crusting. Notably, when the crust of the dough pieces 80 reaches a certain thickness, heat transfer to the center of the dough pieces 80 slows down, such that the temperature of the crust of the dough pieces 80 starts to rise, and provides for the transition to the next key stage of biscuit baking (which occurs in the third section 24c of the tunnel oven 22).

The third section 24c of the tunnel oven 22 is generally associated with color and flavor development. Here, the temperature of the dough pieces 80 being baked in the tunnel oven 22 rises above 212° F. and, after the removal of most of the moisture from the dough pieces 80 is complete, browning of the dough pieces 80 takes place. Typically, three reactions are involved in the browning process: (1) caramelization, which is the breakdown of the sugars at high temperatures leading to both color and flavor development; (2) dextrinization, which is the breakdown of starch molecules at high temperatures producing pyrodextrins which are brown in color and have a distinctive flavor; and (3) Maillard reactions, which are complex interactions between reducing sugars and amino acids at high temperatures.

Without wishing to be limited to theory, since all of these reactions require high temperatures of the dough pieces 80, these reactions typically occur in the last few zones of the tunnel oven 22, which in this case are the zones 26f and 26g of the third section 24c. Notably, baking may not be the final moisture content control step with respect to the baked biscuit products 90, as the (hot) baked products 90 coming out of the tunnel oven 22 are likely to pick up moisture from the ambient environment (if not well-controlled for temperature and humidity) prior to and/or during the cooling and/or packaging of the baked products 90. As such, and depending upon the circumstances, this can allow for compensating for the ambient conditions in the location where the apparatus 10 is installed to minimize and/or avoid undesirable changes to the characteristics (e.g., moisture content, weight, texture, etc.) that may occur as a result of the influence of the ambient conditions during the cooling and/or the packaging of the baked products 90. For some biscuits, after baking the moisture content of the final baked products 90 may be in a range of from about 1% to about 3%.

Each of the zones 26a-26g may be of varying length and width (or the zones 26a-26g may all have an identical length and an identical width). In some embodiments, the total length of the tunnel oven 22 is approximately 100 meters, and the tunnel oven 22 may incorporate a mesh band (for supporting thereon the dough pieces 80 being baked) having a width of approximately 1.5 meters. In some aspects, the dough pieces 80 to be baked in the tunnel oven 22 are deposited onto the mesh band such that 16 dough pieces 80 are positioned across the width of the mesh band, thereby forming 16 lanes of dough pieces 80 traveling through the tunnel oven 22. As will be discussed in more detail below, in some embodiments, the baking time of the dough pieces 80 in the tunnel oven 22 may be adjusted by controlling (e.g., via the controller 40) the speed of the movement of the conveyor 12, which in turn controls the speed of movement of the mesh band on which the dough pieces 80 rest while they are moving through the tunnel oven 22.

It will be appreciated that the number of sections 24a-24c and the number of zones 26a-26g in each of the sections 24a-24c has been illustrated by way of example only, and that, in other embodiments, the tunnel oven 22 may include a different number of sections 24a-24c, and a different number of zones 26a-26g per section 24a-24c. More specifically, while the exemplary tunnel oven 22 has been illustrated in FIG. 3 as having three sections 24a-24c, it will be appreciated that the tunnel oven 22 may have less (e.g., two or one) sections, or more (e.g., 4, 5, 6, etc.) sections, depending on the needs of the baking facility. By the same token, while the exemplary tunnel oven 22 has been illustrated in FIG. 3 as having three zones 26a-26c in the first section 24a, two zones 26d-26e in the second section 24b, and two zones 26f-26g in the third section 24c, it will be appreciated that, depending on the needs of the baking facility, each of the sections 24a-24c may have more zones or less zones than that shown in the example of FIG. 3. In various embodiments, the tunnel oven 22 is configured such that each of the zones 26a-26g in each of the sections 24a-24c is independently heated and independently controlled by the controller 40 (which will be discussed in more detail below). For example, in some aspects, the air temperature of each of the zones 26a-26g is controlled separately via the controller 40, and the temperature in each of the zones 2a-26g is measured using resistance thermometer detectors (RTDs) or thermocouples.

In some embodiments, the tunnel oven 22 uses indirect convective heat as the main heat transfer mode for baking the dough pieces 80 to make the baked products 90. In one aspect, each of the zones 26a-26g includes one burner that generates the heat required for the entire zone 26a-26g, and the hot combustion air from the burner passes through a heat exchanger and heats up the recirculated air in the interior (i.e., bake chamber) of the zone 26a-26g. In some embodiments, the air flow to the top and bottom of each zone 26a-26g (i.e., baking chamber) is controlled by one or more (e.g., two) dampers 30a-30g.

In some embodiments (see, e.g., FIG. 2), the tunnel oven 22 includes an exhaust damper 30a-30g in every one of the zones 26a-26g of the tunnel oven 22, and the humidity in the tunnel oven 22 is controlled by an exhaust damper 30a-30g for every zone 26a-26g. In some embodiments, the exhaust dampers 30a-30g are motorized and controlled by programmable logic controllers (PLCs), which may be controlled by one or more control signals sent by the controller 40 over the network 36.

With reference to FIGS. 1 and 3, in some embodiments, the apparatus 10 further includes at least one sensor 32 configured to detect the operational parameters of the tunnel oven 22. The at least one sensor 32 may be internal to the tunnel oven 22 (as shown in FIGS. 1 and 2) and/or external to the tunnel oven 22. More specifically, in some aspects, the sensor 32 is a set of sensors 32a-32g operational coupled to each one of the zones 26a-26g of the tunnel oven 22 and configured to detect one or more of the operational parameters (e.g., temperature, humidity, air circulation speed, top heat, bottom heat, exhaust, etc.) in each one of the zones 26a-26g of the tunnel oven 22. In some aspects, the second sensor 32 (which may be a single sensor or a set of multiple sensors) is configured for communication with the controller 40 (which will be described in more detail below), such that the second sensor 32 is able to detect/determine the operational parameters in each of the zones 26a-26g of the tunnel oven 22, and to transmit this information over the network 36 to the controller 40.

With reference to FIGS. 1 and 3, in some embodiments, the apparatus 10 further includes at least one sensor 34 configured to detect the characteristics/attributes of the final baked products 90 (e.g., biscuits, cookies, crackers, etc.) coming out of the tunnel oven 22. More specifically, in some aspects, the third sensor 34 is either a single sensor or a set of multiple sensors positioned (e.g., at the end of the tunnel oven 22 or downstream relative to the end of the tunnel oven 22) to detect the characteristics/attributes of the final baked products 90 coming out of the tunnel oven 22. In some embodiments, the third sensor 34 comprises and/or is a soft-sensor (also known as a software sensor). In some aspects, the third sensor 34 is a soft sensor that measures/detects the color (e.g., top color), stack height, weight, etc. of the baked products 90 coming out of the tunnel oven 22. In one approach, the top color of the baked products 90 is measured by a machine vision system, and the stack height of the baked biscuit products 90 is measured by a laser distance measuring device. In some aspects, the third sensor 34 (which, again, may be a single sensor, or a set of multiple sensors) is configured for two-way communication with the controller 40 (which will be described in more detail below), such that the third sensor 34 is able to detect/determine the characteristics/attributes of the baked products 90 prepared in the tunnel oven 22, and to transmit this information over the network 36 to the controller 36.

In some embodiments, the characteristics/attributes of the final baked products 90 detected by the third sensor 34, and which indite the key quality attributes of the baked products 90, include, but are not limited to, texture and flavor. The exemplary texture characteristics of the baked products 90, which may be detected by the third sensor 34, may include but are not limited to: (1) hardness (e.g., the strength required to break off a piece of the baked product 90 by biting it using the teeth and tongue and/or using fingers); (2) crunchiness (e.g., whether the baked product 90 is more difficult to chew/grind using teeth or whether it melts completely in the mouth after intake), and (3) smoothness (e.g., the degree of roughness or grittiness of the baked product 90 experience while chewing).

In some aspects, the third sensor 34 and/or the controller 40 may be configured to interpret the texture of the baked products 90 as being dependent on the volume of expansion of the dough pieces 80 during the baking process and measured as density, which itself can be measured by the sensor 34 as the weight and thickness (stack height) of the final baked products 90 coming out of the tunnel oven 22. Another key attribute of the final baked products 90 is flavor, which, in some embodiments, may be correlated by the controller 40 to the color of the baked biscuit products 90 that is detected/measured by the sensor 34. Another key attribute of the baked biscuit products 90 that may be detected/measured by the sensor 34 in some embodiments is moisture content of the final baked products 90, which impacts both the texture and the flavor of the final baked products 90 coming out of the tunnel oven 22. Generally, the characteristics/attributes of the final baked products 90 coming out of the tunnel oven 22 and measured by the sensor 34 represent the quality (commercial desirability) of the final baked products 90. As such, the apparatus 10 aims to improve one or more of these attributes of the final biscuit products 90 (e.g., by adjusting the parameters of the tunnel oven 22 to achieve optimal moisture content, weight, stack height and color during baking) in order to consistently and repeatedly improve the quality of the final products 90.

With reference to FIG. 1, the exemplary apparatus 10 further includes a controller 40 configured to communicate with the tunnel oven 22, the first sensor 28, the second sensor 32, the third sensor 34, as well as with any of the other components of the apparatus 10 directly over a wired connection or wirelessly over a network 36. The exemplary network 36 depicted in FIG. 1 may be a wide-area network (WAN), a local area network (LAN), a personal area network (PAN), a wireless local area network (WLAN), Wi-Fi, Zigbee, Bluetooth (e.g., Bluetooth Low Energy (BLE) network), or any other internet or intranet network, or combinations of such networks. Generally, communication between various electronic devices of apparatus 10 may take place over hard-wired, wireless, cellular, Wi-Fi or Bluetooth networked components or the like. In some aspects, one or more electronic devices of the apparatus 10 may include cloud-based features, such as cloud-based computer vision application programming interfaces (APIs), cloud-based memory storage, etc.

Generally, the controller 40 may be a stationary or portable electronic device, for example, a desktop computer, a laptop computer, a tablet, a mobile phone, or any other electronic device including a control circuit (i.e., control unit) that includes a programmable processor. The controller 40 may be configured for data entry and processing as well as for communication with the other devices of the apparatus 10 (e.g., the devices shown in FIG. 1).

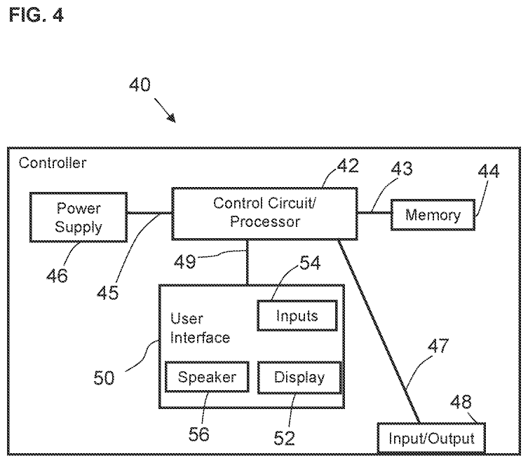

With reference to FIG. 4, the exemplary controller 40 configured for use in the exemplary apparatus 10 and methods described herein may include a control circuit 42 including a programmable processor (e.g., a microprocessor or a microcontroller) electrically coupled via a connection 43 to a memory 44 and via a connection 45 to a power supply 46. The control circuit 42 can comprise a fixed-purpose hard-wired platform or can comprise a partially or wholly programmable platform, such as a microcontroller, an application specification integrated circuit, a field programmable gate array, and so on.

The control circuit 42 can be configured (for example, by using corresponding programming stored in the memory 44 as will be well understood by those skilled in the art) to carry out one or more of the steps, actions, and/or functions described herein. In some embodiments, the memory 44 may be integral to the processor-based control circuit 42 or can be physically discrete (in whole or in part) from the control circuit 42 and is configured non-transitorily store the computer instructions that, when executed by the control circuit 42, cause the control circuit 42 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Accordingly, the memory 44 and/or the control circuit 42 may be referred to herein as a non-transitory medium or non-transitory computer readable medium.

In the exemplary embodiment shown in FIG. 4, the control circuit 42 of the controller 40 is also electrically coupled via a connection 47 to an input/output 48 that can receive signals from, for example, the first, second and third sensors 28 (28a, 28b), 32, and 34, respectively, the electronic database 38, etc. The input/output 48 of the controller 40 can also send signals to other devices of the apparatus 10, for example, a signal to the electronic database 38 to store and update predictive multivariate data control models associated with the operational parameters of the piece forming device 16 and/or the tunnel oven 22, predictive multivariate data control models associated with the characteristics of the dough pieces 80 formed in the dough piece forming device 16, as well as predictive multivariate data control models associated with the attributes of the baked products 90 produced in the tunnel oven 22 from the dough pieces 80.

The exemplary processor-based control circuit 42 of the controller 40 shown in FIG. 4 is electrically coupled via a connection 49 to a user interface 50, which may include a visual display or display screen 52 (e.g., LED screen) and/or button input 54 that provide the user interface 50 with the ability to permit an operator of the controller 40 (e.g., a worker at baked product manufacturing plant tasked with controlling and/or monitoring the apparatus 10) to manually control the controller 40 by inputting commands via touch-screen and/or button operation and/or voice commands. Possible commands may, for example, cause the controller 40 to cause transmission of a control signal over the network 36 to the transceiver 30 of the tunnel oven 22 in order to preset or adjust (in real-time while the dough pieces 80 are baking) the operational parameters (e.g., heat, humidity, etc.), of the tunnel oven 22.

In some aspects, the manual control by an operator of the controller 40 may be via the user interface 50 of the controller 40, via an electronic device of the operator (e.g., mobile phone, tablet, etc.), or via another user interface and/or switch. In one aspect, the user interface 50 may be configured to include an option to modify/update the predictive data models associated with: (1) the operational parameters of the tunnel oven 22; (2) the characteristics of the dough pieces 80 formed in the dough piece forming device 16; and (3) the attributes of the final baked products 90 produced in the tunnel oven 22 from the dough pieces 80. In some embodiments, the user interface 50 of the controller 40 may also include a speaker 56 that provides audible feedback (e.g., alerts) to the operator of the controller 40. It will be appreciated that the performance of such functions by the control circuit 42 is not dependent on a human operator, and that the control circuit 42 may be programmed to perform such functions without a human operator.

With reference to FIG. 1, the exemplary apparatus 10 includes an electronic database 38. In some embodiments, the electronic database 38 and the controller 40 may be implemented as two separate physical devices. It will be appreciated, however, that the controller 40 and the electronic database 38 may be implemented as a single physical device in some embodiments. In some aspects, the electronic database 38 may be stored, for example, on non-volatile storage media (e.g., a hard drive, flash drive, or removable optical disk) internal or external to the controller 40, or internal or external to computing devices distinct from the controller 40. In some embodiments, the electronic database 38 may be cloud-based.

Generally, the exemplary electronic database 38 of FIG. 1 is configured to store various electronic data associated with the preparation of the baked products 90. Some exemplary electronic data that may be stored in the electronic database 38 includes but is not limited to: (1) electronic data indicating the ingredients and relative amounts of the ingredients of the baked biscuit products 90; (2) electronic data corresponding to current and historical ambient environmental conditions (e.g., relative humidity, temperature, etc.) at the location of the apparatus 10; (3) sensor data generated by the first sensor 28 (e.g., 28a and/or 28b) while detecting the operational parameters of the kibbler 18 and/or rotary molder 20 of the piece forming device 16 and/or the dough pieces 80 produced in the kibbler 18 and/or rotary molder 20 of the piece forming device 16; (4) sensor data generated by the sensor 32 while sensing/determining the operational parameters (heat, temperature, humidity, etc.) of the tunnel oven 22; (5) sensor data generated by the sensor 34 while sensing/determining the attributes (e.g., moisture, thickness, color, weight, stack height, etc.) of the final baked products 90 produced in the tunnel oven 22; (6) predictive multivariate data control models associated with the operational parameters of the tunnel oven 22; (7) predictive multivariate data control models associated with the characteristics of the dough pieces 80 formed in the dough piece forming device 16; and (8) predictive multivariate data control models associated with the attributes of the final baked products 90 produced in the tunnel oven 22 from the dough pieces 80.

In some embodiments, the exemplary electronic database 38 may store electronic data representing: (1) feedforward variables such as dough temperature, dough rheology, dough moisture, ambient temperature, dough lay time (e.g., prior to going into the piece forming device 16), hopper level (e.g., of the rotary molder 20); (2) manipulated variables such as die roll speed, corrugated roll gap, rubber roll gap, knife height, and extraction rate (in an example using the rotary molder 20, it being understood that these variable could vary if other technologies, e.g., sheet or extruding, are used), as well as the temperature, recirculation speed, top heat %, bottom heat %, and exhaust % in each of the zones 26a-26g of the tunnel oven 22; (3) controller variables relating to setpoint control, such as dough weight, biscuit weight, height, roundness, and moisture; and (4) controlled variables relating to the constraints control, such as oven band temperature, pressure in each of the zones 26a-26g, exit temperature of the tunnel oven 22, and exit humidity of the tunnel oven 22. In some embodiments, the controller 40 is programmed to obtain this data from the electronic database 38, and analyze this data in order to determine a set of baking parameters for the piece forming device 16 and/or the tunnel oven 22, which would be predicted by the controller 42 to result in final baked products 90 having key attributes that most closely match the target model (i.e., commercially desirable) final baked products 90. More specifically, in some embodiments, the processor of the control circuit 42 of the controller 40 is programmed to analyze/correlate the aforementioned feedforward variables, manipulated variables, set point control-related controlled variables, and constraints control-related control variables, and to use these variables to self-train for generating predictions (e.g., generate model coefficients (steady-state process gain) correlating the variables of the dough, ambient conditions, and operational parameters of the piece forming device 16 and the tunnel oven 22 (e.g., on a zone-by-zone basis) to the attributes of the final baked products 90.

In some embodiments, the control circuit 42 of the controller 40 is configured to obtain from the first sensor 28 (e.g., over the network 36) the electronic data representing one or more parameters associated with the dough pieces 80 formed by the piece forming device 16 and detected by the first sensor 28. As discussed above, such parameters may include, but are not limited to the current, power, and/or torque of the kibbler 18 and/or the die roll speed and/or roll gap and/or knife height of the rotary molder 20, and/or texture and moisture content of the dough pieces 80. In various implementations, the control circuit 42 of the controller 40 is also configured to obtain from the electronic database 38 (e.g., over the network 36) the electronic data representing target (i.e., commercially desirable) parameters of the baked biscuit products 90 to be manufactured in the tunnel oven 22 from the dough pieces 80. In addition, in certain embodiments, the control circuit 42 of the controller 40 is also configured to obtain from the first sensor 28 (e.g., over the network 36) the electronic data representing the settings (e.g., current, voltage, power, torque, speed, pressure, etc.) of the kibbler 18 and/or the settings (e.g., die roll speed, die roll gap, knife height, extraction rate, etc.) of the rotary molder 20, and to obtain from the second sensor 32 (e.g., over the network 36) the electronic data representing the settings (e.g., heat, damper position, etc.) and/or conditions (temperature, humidity, etc.) of the tunnel oven 22.

In some embodiments, the processor of the control circuit 42 of the controller 40 is programmed to correlate the obtained parameters of the dough pieces 80, target parameters of the baked biscuit products 90, the ambient environmental conditions, the settings and conditions of the piece forming device 16, and settings and conditions of the tunnel oven 22 to generate, based on a multivariate control model (which includes, but is not limited to, the target moisture, weight, stack height, and color of the baked biscuit products 90), a set of baking parameters for the piece forming device 16 and the tunnel oven 22, which are predicted by the processor of the control circuit 42 of the controller 40 to cause the piece forming device 16 and the tunnel oven 22 to produce, from the dough lumps 70 moved on the conveyor 12 into the piece forming device 16 and from the dough pieces 80 produced in the piece forming device and moved on the conveyor 12 into the tunnel oven 22, the baked products 90 having characteristics/attributes that are as closely matched as possible to the target parameters of the commercially desirable baked products 90. In other words, the processor of the controller 40 is programmed to analyze the attributes of the starting material (i.e., the dough pieces 80), the attributes of the target final product (i.e., the model attributes that represent a commercially desirable biscuit product 90), as well as the ambient conditions, and the operational parameters/conditions of the piece forming device 16 and the tunnel oven 22 in order to predict the parameters/settings of the piece forming device 16 and the parameters/settings of the tunnel oven 22 that will turn the dough lumps 70 into the dough pieces 80 and then the dough pieces 80 into the baked products 90 that match the target final product characteristics as closely as possible.

In one approach, the controller 40 is programmed to transmit (e.g., via its input/output 48) a control signal over the network 36 to the transceiver 17 of the piece forming device 16 in order to control the piece forming device 16 (e.g., the kibbler 18 and/or the rotary molder 22) to run a set of baking parameters (generated by the processor of the control circuit 42 of the controller 40 based on the correlation of the above-described electronic data obtained by the controller 40) while the dough lumps 70 are being repurposed into the dough pieces 80 in the piece forming device 16. By the same token, in one approach, the controller 40 is programmed to transmit (e.g., via its input/output 48) a control signal over the network 36 to the transceiver 30 of the tunnel oven 22 in order to control the tunnel oven 22 to run a set of baking parameters (generated by the processor of the control circuit 42 of the controller 40 based on the correlation of the above-described electronic data obtained by the controller 40) while the dough pieces 80 are baked in the tunnel oven 22 to result in the final baked products 90. In other words, the making of the dough pieces 80 in the piece forming device 16, as well as the baking of the dough pieces 80 in the tunnel oven 22 according to the set of baking parameters generated, and imposed onto the piece forming device 16 and onto the tunnel oven 22, by the controller 40 are predicted by the controller 40 to result in baked products 90 that match the model target parameters of the commercially desirable baked products 90 to be sold to consumers.

In some embodiments, the controller 40 obtains readings from the first sensor 28 and from the second sensor 32 continuously in order to continuously monitor the operational parameters of the piece forming device 16 as well as the operational parameters of the tunnel oven 22 in order to ensure that the piece forming device 16 and the tunnel oven 22 are operating according to the set of target parameters transmitted by the controller 40 to the transceiver 17 of the piece forming device 16 and to the transceiver 30 of the tunnel oven 22 in respective control signals. As such, the making of the dough pieces 80 from the dough lumps 70 in the piece forming device 16, as well as the baking of the dough pieces 80 during their movement through the tunnel oven 22 may be continuously monitored/controlled by the controller 40 by way of continuously obtaining sensor data from the sensors 28 and 32, and controlling (e.g., adjusting) the operational parameters of the piece forming device 16 and/or the tunnel oven 22.

It will be appreciated that, in some aspects, the controller 40 is configured to monitor and/or control the operational parameters of the tunnel oven 22 (i.e., via obtaining sensor data from the sensors 28 and 32) not only continuously, but also intermittently (i.e., at predetermined periodic intervals), and/or responsively (e.g., in response to determining that the sensor data obtained from the sensors 28 and/or sensor 32 indicates that the operational parameters of the piece forming device 16 and/or tunnel oven 22 are outside of the range of expected operational parameters. In one approach, if the controller 40 determines that the operational parameters and/or ambient conditions of the piece forming device 16 and/or tunnel oven 22 during dough piece making and/or during baking have deviated from the set of target parameters transmitted by the controller 40 to the piece forming device 16 and/or tunnel oven 22, the processor of the controller is programmed to transmit another control signal to the transceiver 17 of the piece forming device 16 and/or the transceiver 30 of the tunnel oven 22 in order to adjust the operational parameters of the piece forming device 16 (e.g., the kibbler 18 and/or the rotary molder 20) and/or the tunnel oven 22 such that the adjusted operational parameters of the piece forming device 16 and/or the tunnel oven 22 meet the first set of operational parameters initially determined to be optimal by the controller 40 and transmitted to the piece forming device 16 and tunnel oven 22.

In some embodiments, the multivariate predictive control model used by the controller 40 in conjunction with predicting, based on the attributes (e.g., moisture content, texture, etc.) of the dough lumps 70 going into the dough piece forming device 16 and/or the dough pieces 80 coming out of the dough piece forming device 16, the ambient conditions, and the parameters (e.g., moisture content, texture, stack height, color, etc.) of the target (i.e.,commercially desirable) baked biscuit products 90, the operational parameters of the piece forming device 16 and/or of the tunnel oven 22 most likely to transform the dough lumps 70 going into the piece forming device 16 and subsequently the dough pieces 80 going into the tunnel oven 22 on the conveyor 12 into the commercially desirable baked products 90 that most closely match the target/model characteristics associated with the commercially desirable baked products 90. In particular, as mentioned above, since the plasticity of the dough may be inferred by the processor of the controller 40 from sensor data indicative of the motor current of the kibbler 18 of the piece forming device 16, the control model used by the controller 40 may define the degree of baking required so as to achieve a final baked biscuit product 90 having the target parameters. In some embodiments, for example, the processor of the controller 40 may be programmed to interpret the color values (e.g., L, a, and b) of the baked biscuit products 90 produced in the tunnel oven 22 and sensed by the third sensor 34 (positioned at the exit of the tunnel oven 22 or downstream of the tunnel oven 22) to reflect the flavor characteristics of the final biscuit products 90.

As explained above, in some embodiments, the measurement (e.g., in real-time) of the controllable variables (e.g., current, voltage, power, torque, speed, pressure, etc.) of the piece forming device 16 as well as the controllable variables (e.g., temperature, humidity, pressure, dampers, exhausts, fans, the gap of the baking aperture, mesh band speed, throughput, etc.) of the tunnel oven 22 are transmitted by the sensors 28 and 32 over the network 36 to the controller 40, which is a Model Predictive Controller (MPC) configured to control the process of making of the dough pieces 80 in the piece forming device 16 and the process of baking the biscuit products 90 from the dough pieces 80 in the tunnel oven 22 with a consistently low variability in the key quality attributes (e.g., moisture content, weight, stack height, color, etc.) of the biscuit products 90, while potentially maximizing the baking throughput of the tunnel oven 22.

Generally, MPC is an advanced method of process control, where a set of constraints is satisfied and finite time-horizon optimization is achieved by predicting future events and taking control actions with respect to the underlying process in accordance with the prediction. As pointed out above, in the baking process according to some of the embodiments of the apparatus 10, the controller 40 is programmed to generate a first set of operational parameters for the piece forming device 16 and for the tunnel oven 22, and more specifically, operational parameters (e.g., current, power, torque, die roll speed, die roll gaps, knife height, etc.) for the kibbler 18 and/or rotary molder 20 of the piece forming device 16, as well as the operational parameters (e.g., temperature setting, damper setting, recirculation fan setting, etc.) for at least one of the zones 26a-26g in at least one of the sections 24a-24c of the tunnel oven 22 in view of the predictive control model-based optimal set-points with the aim of achieving target key quality attributes of the resulting baked products 90.

In some embodiments, the predictive control model is trained using the sensor data obtained in connection with a certain number of batch runs of the baked biscuit products 90 in the tunnel oven 22. This training of the predictive control model may be achieve using, for example, various algorithms, mathematical modelling, numerical regression (e.g., linear and non-linear regression), and/or machine learning (e.g., generalized linear model (GLM), a random forest, logistic regression, a support vector machine, K-nearest neighbors, a decision tree, AdaBoost, XGBoost, a neural network (e.g., convolutional neural network (CNN), recurrent neural network (RNN), long short-term memory (LSTM), feedforward neural network (FFNN), TensorFLow, neural architecture learning, transfer learning, Google AutoML, etc.), time-series classification, a recurrence plot, a linear mixed model, and/or a combination of two or more thereof).

As mentioned above, the controller 40 is configured to obtain readings from the third sensor 34 after the final baked biscuit products 90 come out of the tunnel oven 22. In some embodiments, the processor of the controller 40 is programmed to analyze the readings obtained from the third sensor 34 to determine whether the first set of operational parameters generated by the controller 40 based on the control model used by the controller 40 (and transmitted to the piece forming device 16 and to the tunnel oven 22 to control the dough piece forming process and the dough piece baking process) actually resulted in baked products 90 having the characteristics that were predicted by the controller 40 to result in in view of the above-described multivariate predictive control model-based analysis. In one approach, if the controller 40 determines that the final characteristics (e.g., moisture, texture, stack height, color) of the resulting baked products 90 deviate from the final characteristics that were predicted by the controller 40 to result in view of the multivariate predictive control model, the processor of the controller 40 is programmed to modify (i.e., retrain) the control model in view of the detected deviations. Such an adjustment of the control model in view of the detected prediction inaccuracies with respect to the final product attributes in one or more batch runs would be expected to increase the prediction accuracy of the multivariate predictive control model with respect to the correlating of the operational parameters of the piece forming device 16 and/or the tunnel oven 22 to the attributes of the final products 90 in subsequent batch runs.

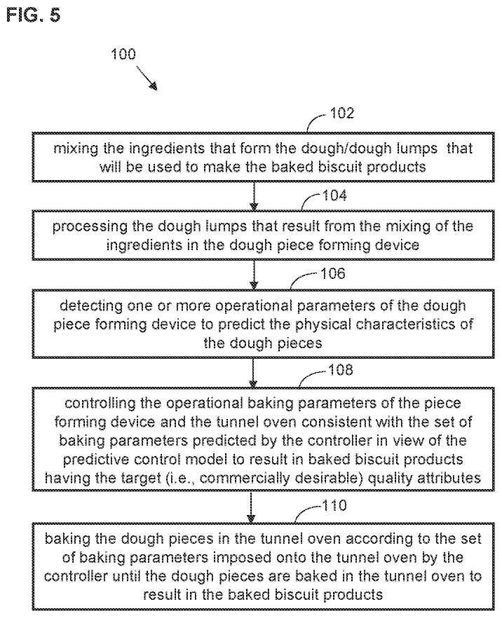

With reference to FIG. 5, a method 100 of controlling the processing of baked products 90 (e.g., biscuits, cookies, crackers, or the like) will now be described. Step 102 of the exemplary method 100 shown in FIG. 5 includes mixing (e.g., in a mixer) the ingredients (e.g., various combinations of flour, water, sugar, oil, salt, emulsifier, etc.) that form the dough that will be used to make the baked products 90 (step 102). To that end, as described above, the exemplary apparatus 10 of FIG. 1 according to some embodiments may include a mixer 15, where the dough ingredients may be mixed to achieve one or more dough lumps 70 having the consistency, texture, and/or temperature desirable for achieving commercially desirable final baked products 90. Notably, in some embodiments of the method 100, step 102 may be optional, as the method 100 may involve the processing of dough lumps 70 and/or co-extruded dough bits, or the like that have been pre-made (i.e., independently of the apparatus 10 and the method 100), and may initially start with step 104, which is described below.

With reference to FIG. 5, step 104 of the method 100 includes processing the dough lumps 70 (resulting from the aforementioned mixing of the ingredients) in the dough piece forming device 16. In particular, as described above, step 102 may include the dough lumps 70 traveling on the product-supporting surface of the conveyor 12 through the dough piece forming device 16, such that the dough lumps 70 are kibbled (e.g., by the kibbler 18 of the dough piece forming device 16) and then formed into the dough pieces 80 (e.g., by the rotary molder 20 of the dough piece forming device 16), which become the precursors of the baked products 90.

At step 106 of the exemplary method 100 of FIG. 5, a first process output associated with the forming of the dough pieces 80 is detected/determined. In particular, in some embodiments, step 106 of method 100 includes using at least one sensor 28 to detect at least one operational parameter of the dough piece forming device 16 (e.g., voltage, power, torque, speed and/or pressure of the kibbler 18), and translating the sensed one or more operational parameters of the dough piece forming device 16 into a predicted physical characteristic (e.g., consistency, thickness, viscosity, etc.) of the dough pieces 80 formed from the dough lumps 70 in the dough piece forming device 16.

As described above, in some embodiments, the control circuit 42 of the controller 40 is configured to obtain: (1) electronic data representing the parameters of the dough pieces 80 formed by the piece forming device 16 and detected by the first sensor 28; (2) electronic data representing target (i.e., commercially desirable) parameters (e.g., moisture content, weight, stack height, color, etc.) of the baked products 90 to be manufactured in the tunnel oven 22 from the dough pieces 80; (3) ambient environmental conditions at the location where the process 100 is performed; and (4) electronic data representing the settings and/or conditions of the piece forming device 16 (e.g., current, power, torque, die roll speed, die roll gaps, knife height, etc.) for the kibbler 18 and/or rotary molder 20 of the piece forming device 16) and/or the settings and/or conditions (e.g., temperature, humidity, pressure, dampers, exhausts, fans, the gap of the baking aperture (e.g., a nip of adjustable nip of baking rollers), mesh band speed, and throughput) of the tunnel oven 22. In various implementations, after obtaining such data, the processor of the control circuit 42 of the controller 40 is programmed to correlate the obtained parameters of the dough pieces 80, target parameters of the baked biscuit products 90, ambient environmental conditions, settings and conditions of the piece forming device 16, and the settings and conditions of the tunnel oven 22.

In some embodiments, based on the correlation, the processor of the controller 40 generates, in view of a multivariate predictive control model (which includes, but is not limited to, the target moisture, weight, stack height, and color of the baked products 90) programmed into the processor of the controller 40, a first set of baking parameters for the piece forming device and/or for the tunnel oven 22, which are predicted by the processor of the controller 40 to cause the piece forming device and the tunnel oven 22, in combination, to produce, from the dough lumps 70 inserted into the piece forming device 16 and the dough pieces 80 inserted into the tunnel oven 22, final baked products 90 having key quality attributes (e.g., moisture content, weight, stack height, color, etc.) that are as closely matched as possible to the target parameters of the commercially desirable baked products 90.

In certain aspects, after generating the first set of baking parameters for the piece forming device 16 and/or the tunnel oven 22, the processor of the control circuit 42 of the controller 40 is programmed to cause the controller 40 to transmit a control signal to the piece forming device 16 and/or the tunnel oven 22, respectively, in order to control the piece forming device 16 and/or the tunnel oven 22 to run the first set of baking parameters generated by the processor of the control circuit 42 of the controller 40 while the dough pieces 80 are being made from the dough lumps 70 in the piece forming device 16 and while the dough pieces 80 are being baked in the tunnel oven 22. To that end, step 108 of the exemplary method 100 of FIG. 5 includes controlling the operational parameters of the piece forming apparatus and/or the baking parameters of the tunnel oven 22 consistent with the first set of baking parameters generated by the controller based on the multivariate predictive control model. At step 110 of the exemplary method 100 the dough pieces 80 are baked in the tunnel oven 22 to result in the baked biscuit products 90 by way of being moved via the conveyor 12/band mesh through the tunnel oven 22 while the controller 40 is controlling the operational parameters in each of the zones 26a-26g in each of the sections 24a-24c of the tunnel oven 22.

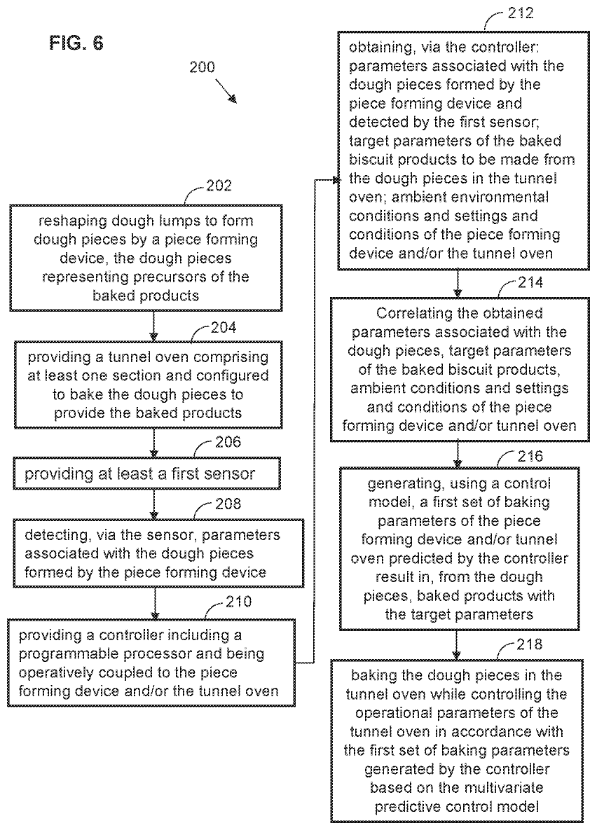

FIG. 6 depicts another embodiment of a method 200 of controlling manufacture of baked products 90 (e.g., biscuits, cookies, crackers, etc.). The exemplary method depicted in FIG. 6 includes reshaping dough lumps 70 to form dough pieces 80 by a piece forming device 16, the dough pieces representing precursors of the baked biscuit products (step 202). The exemplary method 200 further includes providing a tunnel oven 22 comprising at least one section 24a-24c and configured to bake the dough pieces 80 to provide the baked biscuit products 90 (step 204). The exemplary method 200 further includes providing at least a first sensor 28 (step 206) and detecting, via the first sensor 28, parameters associated with the dough pieces 80 formed by the piece forming device 16 (step 208).

In addition, the exemplary method 200 of FIG. 6 further includes providing a controller 40 including a programmable processor and being operatively coupled to the tunnel oven 22 (step 210). The method 200 further includes, obtaining, via the controller 40: electronic data representing the parameters associated with the dough pieces 70 formed by the piece forming device 16 and detected by the first sensor 28; electronic data representing target parameters of the baked products 90 to be manufactured from the dough pieces 80 in the tunnel oven 22; electronic data representing ambient environmental conditions, and electronic data representing settings and conditions of the tunnel oven 22 (step 212).

In the embodiment illustrated in FIG. 6, the method 200 further includes correlating, by the controller 40, the obtained parameters of the dough pieces 80, the obtained target (i.e., commercially desirable) parameters of the baked products 90, the obtained ambient environmental conditions, and the obtained settings and conditions of the tunnel oven 22 (step 214). Then, based on the correlating step 214, the exemplary method 200 further includes generating, by the controller 40 and using a multivariate predictive control model, a first set of baking parameters of the tunnel oven 22 predicted by the controller 40 to cause the tunnel oven 22 to produce, from the dough pieces 80 inserted into the tunnel oven 22, the baked products 90 having the target (i.e., commercially desirable) parameters (step 216). Finally, the exemplary method 200 of FIG. 6 includes producing the baked products 90 having the target parameters by baking the dough pieces 80 in the tunnel oven 22 while controlling, via the controller 40, the tunnel oven 22 to run the first set of baking parameters, which were generated by the controller 40 in view of the multivariate predictive control model and based on a correlation of the obtained/determined parameters of the dough pieces 80, target parameters of the final baked biscuit products 90, ambient environmental conditions and settings and conditions of the tunnel oven 22 (step 218).

The above described exemplary embodiments of the apparatus and methods of controlling manufacture of baked biscuit products advantageously provide a scalable solution for repeatedly and efficiently producing, in a tunnel oven, batches of baked biscuit products with a consistently low variability between the batches in the key quality attributes (e.g., moisture content, weight, stack height, color, etc.), and with a consistently low variability between the key quality attributes of the baked biscuit products in the production batches and the target key quality attributes assigned to the model commercially desirable baked biscuit products. As such, the apparatus and methods described herein provide for precise and efficient multivariate predictive control model-based baking oven control, which leads to an improved baking efficiency and significant cost savings.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. An apparatus for controlling manufacture of baked products, the apparatus comprising:
a piece forming device configured to form dough pieces by reshaping dough lumps, wherein the dough pieces represent precursors of the baked products;
a tunnel oven comprising at least one section, the tunnel oven being configured to bake the dough pieces to provide the baked products;
at least a first sensor configured to detect parameters of the dough pieces formed by the piece forming device; and
a controller including a programmable processor and being operatively coupled to the tunnel oven, the controller being configured to:
obtain electronic data representing the parameters of the dough pieces formed by the piece forming device and detected by the first sensor;
obtain electronic data representing target parameters of the baked products to be manufactured from the dough pieces in the tunnel oven;
obtain electronic data representing settings and conditions of the tunnel oven;
obtain electronic data representing ambient environmental conditions;
correlate the obtained parameters of the dough pieces, target parameters of the baked products, ambient environmental conditions, and settings and conditions of the tunnel oven to generate, based on a control model, a first set of baking parameters of the tunnel oven predicted by the controller to cause the tunnel oven to produce, from the dough pieces inserted into the tunnel oven, the baked products with the target parameters; and
control the tunnel oven to run the first set of baking parameters, generated by the controller based on a correlation of the obtained parameters of the dough pieces, target parameters of the baked products, ambient environmental conditions, and settings and conditions of the tunnel oven, while the dough pieces are baked in the tunnel oven to produce the baked products having the target parameters.

2. The apparatus of claim 1, wherein the piece forming device includes a kibbler, and wherein the controller is operatively coupled to the kibbler to control at least one of current, voltage, power, torque, speed, and pressure of the kibbler.

3. The apparatus of claim 1, wherein the settings and conditions of the tunnel oven include at least one of temperature, humidity, pressure, dampers, exhausts, fans in the at least one section of the tunnel oven, and throughput of the tunnel oven.

4. The apparatus of claim 1, wherein the target parameters of the baked products include at least one of texture, flavor, moisture content, weight, height, thickness, and color.

5. The apparatus of claim 1, wherein the at least one section of the tunnel oven includes at least one zone independently controllable by the controller.

6. The apparatus of claim 1, wherein the controller is further configured to transmit a control signal to the piece forming device to control the operational parameters of the piece forming device.

7. The apparatus of claim 1, further comprising an electronic database in communication with the controller and configured to store electronic data including:
the electronic data representing the parameters of the dough pieces formed by the piece forming device and detected by the first sensor;
the electronic data representing target parameters of the baked products to be manufactured from the dough pieces in the tunnel oven;
the electronic data representing settings and conditions of the tunnel oven;
the electronic data representing ambient environmental conditions; and
electronic data representing the first set of baking parameters generated by the controller.

8. The apparatus of claim 1,
further comprising at least a second sensor configured to detect parameters associated with the baked products coming out of the tunnel oven; and
wherein the controller is configured to:
obtain electronic data representing the parameters associated the baked products coming out of the tunnel oven and detected by the second sensor;
determine whether the parameters of the baked products coming out of the tunnel oven match the target parameters of the baked products;
if the parameters of the baked products coming out of the tunnel oven do not match the target parameters of the baked products, correlate the obtained parameters associated with the dough pieces, target parameters of the baked products, parameters associated with the baked products coming out of the tunnel oven, ambient environmental conditions, and settings and conditions of the tunnel oven to generate, based on the control model, a second set of baking parameters of the tunnel oven predicted by the controller to cause the tunnel oven to produce, from the dough pieces inserted into the tunnel oven, the baked products with the target parameters.

9. The apparatus of claim 8, wherein the second sensor is configured to measure at least one of a moisture content, thickness, weight, stack height, and color of the baked products coming out of the tunnel oven.

10. The apparatus of claim 8, wherein the electronic database further stores:
the electronic data representing the parameters associated with the baked products coming out of the tunnel oven and detected by the second sensor; and
electronic data representing the second set of baking parameters generated by the controller.

11. The apparatus of claim 1, wherein the piece forming device is configured to reshape the dough lumps into the dough pieces by extruding the dough lumps into a continuous mass, the continuous mass representing the precursors of the baked products.

12-14. (canceled)

15. A method for controlling manufacture of baked products, the method comprising:
reshaping dough lumps to form dough pieces by a piece forming device, the dough pieces representing precursors of the baked products;
providing a tunnel oven comprising at least one section and configured to bake the dough pieces to provide the baked products;
providing at least a first sensor;
detecting, via the first sensor, parameters associated with the dough pieces formed by the piece forming device;
providing a controller including a programmable processor and being operatively coupled to the tunnel oven;
obtaining, via the controller:
electronic data representing the parameters associated with the dough pieces formed by the piece forming device and detected by the first sensor;
electronic data representing target parameters of the baked products to be manufactured from the dough pieces in the tunnel oven;
electronic data representing ambient environmental conditions;
electronic data representing settings and conditions of the tunnel oven;
correlating, by the controller, the obtained parameters of the dough pieces, target parameters of the baked products, electronic data representing ambient environmental conditions, and settings and conditions of the tunnel oven;
based on the correlating, generating by the controller, using a control model, a first set of baking parameters of the tunnel oven predicted by the controller to cause the tunnel oven to produce, from the dough pieces inserted into the tunnel oven, the baked products with the target parameters; and
producing the baked products having the target parameters by baking the dough pieces in the tunnel oven while controlling, via the controller, the tunnel oven to run the first set of baking parameters, generated by the controller based on a correlation of the obtained parameters of the dough pieces, target parameters of the baked products, ambient environmental conditions, and settings and conditions of the tunnel oven.

16. The method of claim 15, wherein the piece forming device includes a kibbler, and wherein the controller is operatively coupled to the kibbler to control at least one of current, voltage, power, torque, speed, and pressure of the kibbler.

17-18. (canceled)

19. The method of claim 15, wherein the at least one section of the tunnel oven includes at least one zone independently controllable by the controller.

20. The method of claim 15, further comprising transmitting, by the controller, a control signal to the piece forming device to control the operational parameters of the piece forming device.

21. The method of claim 15, further comprising providing an electronic database in communication with the controller and configured to store electronic data including:
the electronic data representing the parameters of the dough pieces formed by the piece forming device and detected by the first sensor;
the electronic data representing target parameters of the baked products to be manufactured from the dough pieces in the tunnel oven;
electronic data representing ambient environmental conditions;
the electronic data representing settings and conditions of the tunnel oven; and
electronic data representing the first set of baking parameters generated by the controller.

22. The method of claim 15, further comprising:
providing at least a second sensor configured to detect parameters associated with the baked products coming out of the tunnel oven;
obtaining, via the controller, electronic data representing the parameters of the baked products coming out of the tunnel oven and detected by the second sensor;
determining, by the controller, whether the parameters of the baked products coming out of the tunnel oven match the target parameters of the baked products; and
if the parameters of the baked products coming out of the tunnel oven do not match the target parameters of the baked products, correlating the obtained parameters of the dough pieces, target parameters of the baked products, parameters of the baked products coming out of the tunnel oven, ambient environmental conditions, and settings and conditions of the tunnel oven to generate, based on the control model, a second set of baking parameters of the tunnel oven predicted by the controller to cause the tunnel oven to produce, from the dough pieces inserted into the tunnel oven, the baked products with the target parameters.

23. The method of claim 22, further comprising measuring, via the second sensor, at least one of a moisture content, thickness, weight, stack height, and color of the baked products coming out of the tunnel oven.

24. The method of claim 22, further comprising, storing, in the electronic database:
the electronic data representing the parameters associated the baked products coming out of the tunnel oven and detected by the second sensor; and
electronic data representing the second set of baking parameters generated by the controller.

25. The method of claim 15, wherein reshaping of the dough lumps to form the dough pieces includes extruding the dough lumps into a continuous mass using the piece forming device, the continuous mass representing the precursors of the baked products.

26-28. (canceled)
